(19) United States
(12) Patent Application Publication
(10) Pub. No.: US 2014/0367496 A1
(43) Pub. Date: Dec. 18, 2014

(54) Sprinkler

(71) Applicant: PAI-CHOU HSIEH, HSIU-SHUI TOWNSHIP (TW)

(72) Inventor: PAI-CHOU HSIEH, HSIU-SHUI TOWNSHIP (TW)

(21) Appl. No.: 13/919,017

(22) Filed: Jun. 17, 2013

(51) Int. Cl. B05B 12/00; B05B 15/06; B05B 9/01

(52) U.S. Cl. CPC B05B 12/002; B05B 9/01; B05B 15/061
USPC 239/526

(57) ABSTRACT

A sprinkler includes a handle, a nozzle connected to the handle, a lever connected to the handle and pivotable between an idle position and an active position, and a lever-locking apparatus for locking the lever in the active position. The lever-locking apparatus includes an anchor formed on the handle, a stop formed on the handle, and a catch attached to the lever. The catch is moved on the anchor, stopped by the stop and trapped on the anchor as the lever is pivoted toward the handle and released. The catch is released from the anchor as the lever is again pivoted toward the handle and released.

### BACKGROUND OF INVENTION

1. Field of Invention

The present invention relates to a sprinkler and, more particularly, to an apparatus for locking a lever of a sprinkler.

2. Related Prior Art

The present invention is therefore intended to obviate or at least alleviate the problems encountered in prior art.

### SUMMARY OF INVENTION

It is the primary objective of the present invention to provide a convenient sprinkler.

To achieve the foregoing objective, the sprinkler includes a handle, a nozzle connected to the handle, a lever connected to the handle and pivotable between an idle position and an active position, and a lever-locking apparatus for locking the lever in the active position. The lever-locking apparatus includes an anchor formed on the handle, a stop formed on the handle, and a catch attached to the lever. The catch is moved on the anchor, stopped by the stop and trapped on the anchor as the lever is pivoted toward the handle and released. The catch is released from the anchor as the lever is again pivoted toward the handle and released.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a perspective view of a sprinkler according to the preferred embodiment of the present invention;

FIG. 2 is a perspective view of the sprinkler in another position than shown in FIG. 1;

FIG. 3 is an exploded view of the sprinkler shown in FIG. 1;

FIG. 4 is a side view of an anchor of the sprinkler shown in FIG. 1;

FIG. 5 is a partial, cut-away view of the sprinkler shown in FIG. 1;

FIG. 6 is a partial, cut-away view of the sprinkler in another position than shown in FIG. 5;

FIG. 7 is a partial, cut-away view of the sprinkler in another position than shown in FIG. 6;

FIG. 8 is a partial, cut-away view of the sprinkler in another position than shown in FIG. 7;

FIG. 9 is a partial, cut-away view of the sprinkler in another position than shown in FIG. 8;

FIG. 10 is a partial, cut-away view of the sprinkler in another position than shown in FIG. 9; and

FIG. 11 is a partial, cut-away view of the sprinkler in another position than shown in FIG. 10.

### DETAILED DESCRIPTION OF PREFERRED EMBODIMENT

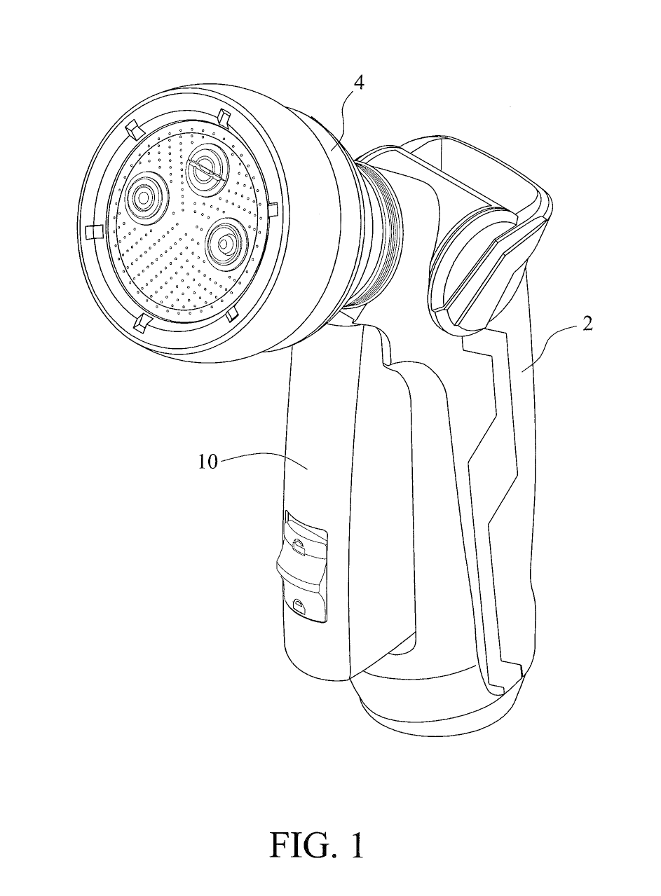

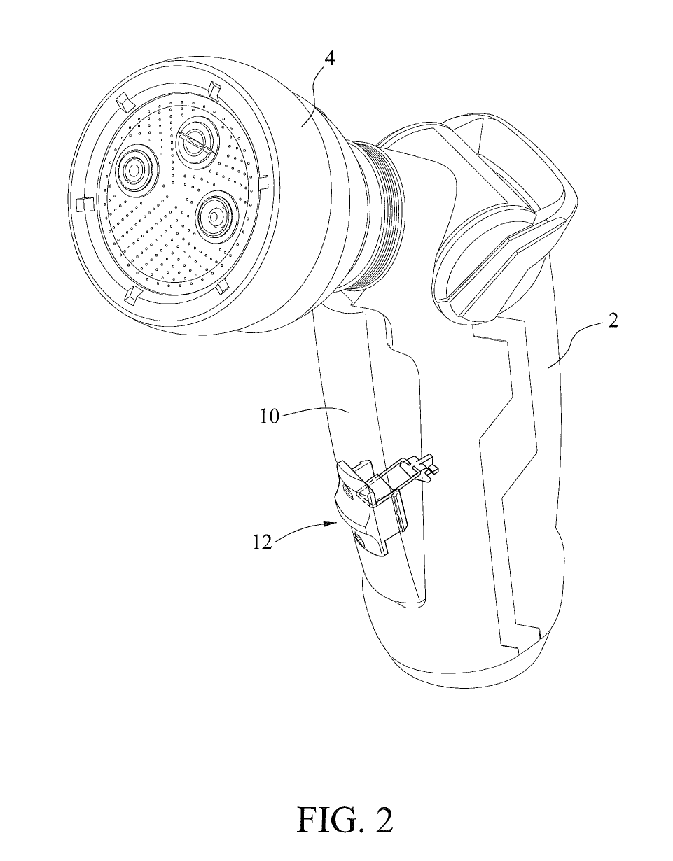

Referring to FIGS. 1 through 3, a sprinkler includes a handle 2, a nozzle 4, a plunger 6, a spring 8, a lever 10 and a lever-locking apparatus 12 according to the preferred embodiment of the present invention. The handle 2 is a hollow element for receiving at least one valve (not shown). The nozzle 4 is connected to the handle 2. The plunger 6 includes an end in contact with the valve and another end in contact with the lever 10, which is pivotally connected to the handle 2. The spring 8 is compressed between the handle 2 and the plunger 6. The spring 8 tends to keep the lever 10 in an idle position as shown in FIG. 1. In the idle position, water is not sprayed from the nozzle 4. The lever 10 can be pivoted to an active position as shown in FIG. 2. In the active position, water is sprayed from the sprinkler. The lever 10 can be locked in the active position by the lever-locking apparatus 12. Thus, a user does not have to press the lever 10 against the spring 8 when he or she sprays water from the nozzle 4.

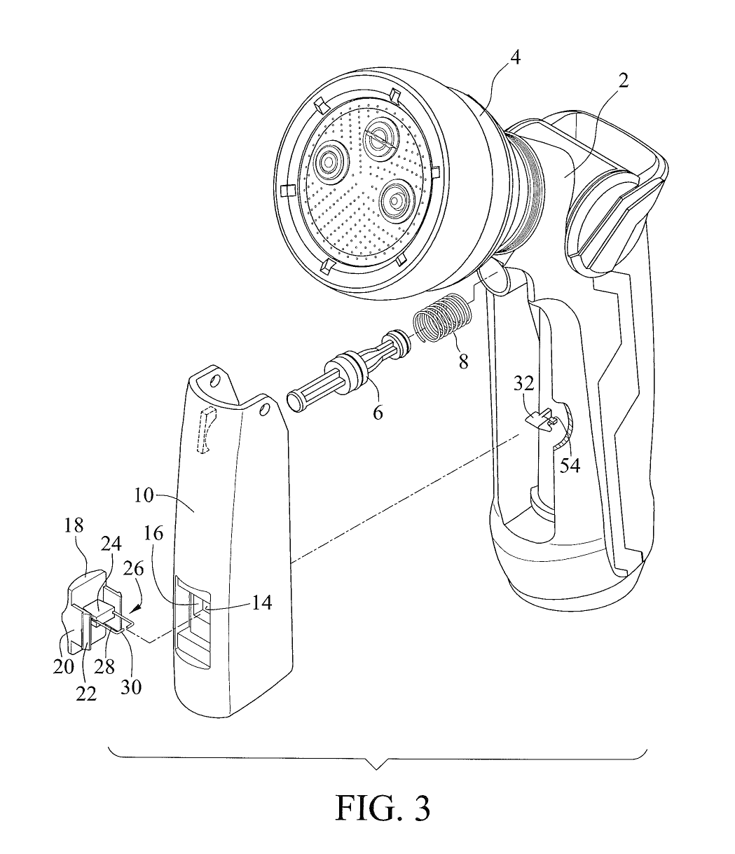

Referring to FIG. 3, the lever 10 includes an opening 14 made therein. The lever 10 further includes two tracks 16. The opening 14 is located between the tracks 16.

The lever-locking apparatus 12 includes a switch 18. The switch 18 includes a skid-proof portion formed on a front face. The switch 18 includes two hooks 20 formed on a rear face and two barbs 22. Each of the hooks 20 includes a barb 22 formed at a free end (or “edge”). Each of the hooks 20 is a flat element except the barb 22. The hooks 20 extend parallel to each other. The switch 18 further includes a block 24 formed on the rear face.

The hooks 20 are inserted through the opening 14. The barbs 22 are engaged with the tracks 16. The hooks 20 are limited between the tracks 16. Thus, the switch 18 is smoothly movable on a front face of the lever 10.

The lever-locking apparatus 12 further includes a catch 26. The catch 26 is made by bending a metal wire so that it is elastic. The catch 26 includes a middle portion extending two prongs 28. Each of the prongs 28 is formed with a transverse end 30. The middle portion of the catch 26 is entirely embedded in the block 24 when the switch 18 is formed. Each of the prongs 28 is partially embedded in the block 24 when the switch 18 is formed.

The lever-locking apparatus 12 further includes an anchor 32. The anchor 32 includes a root extending from a front face of the handle 2 and a head formed at a free end of the root.

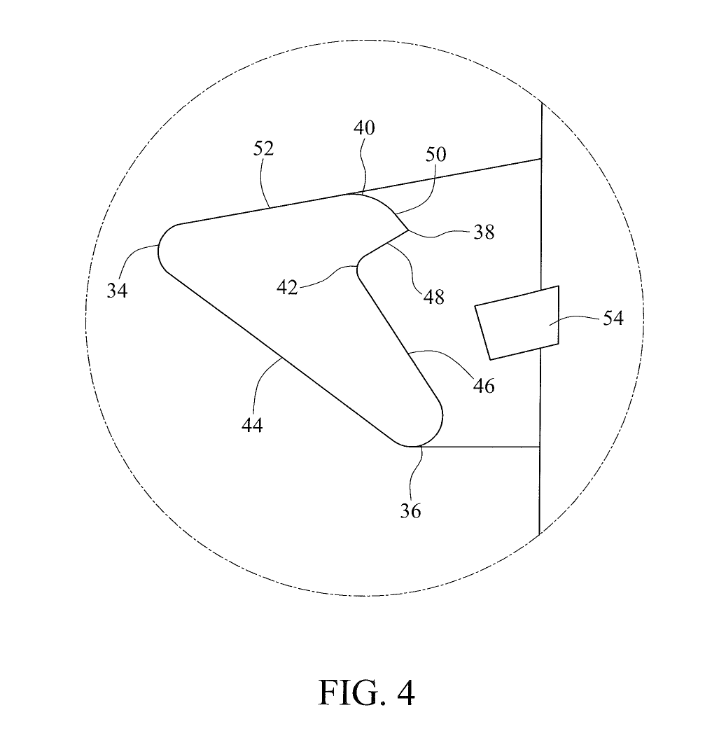

Referring to FIG. 4, the head of the anchor 32 includes four corners 34, 36, 38 and 40, a recess 42 and five facets 44, 46, 48, 50 and 52. The corners 34, 36, 38 and 40 are chamfered for smooth operation of the lever-locking apparatus 12 to be described. The corner 34 is furthest from the front face of the handle 2. The facet 44 extends between the corners 34 and 36. The facet 46 extends between the corners 36 and the recess 42. The facet 48 extends between the recess 42 and the corner 38. The facet 50 extends between the corners 38 and 40. The facet 52 extends between the corners 40 and 34.

The lever-locking apparatus 12 further includes two stops 54 formed on the front face of the handle 2. The stops 54 are on two opposite sides of the root of the anchor 32.

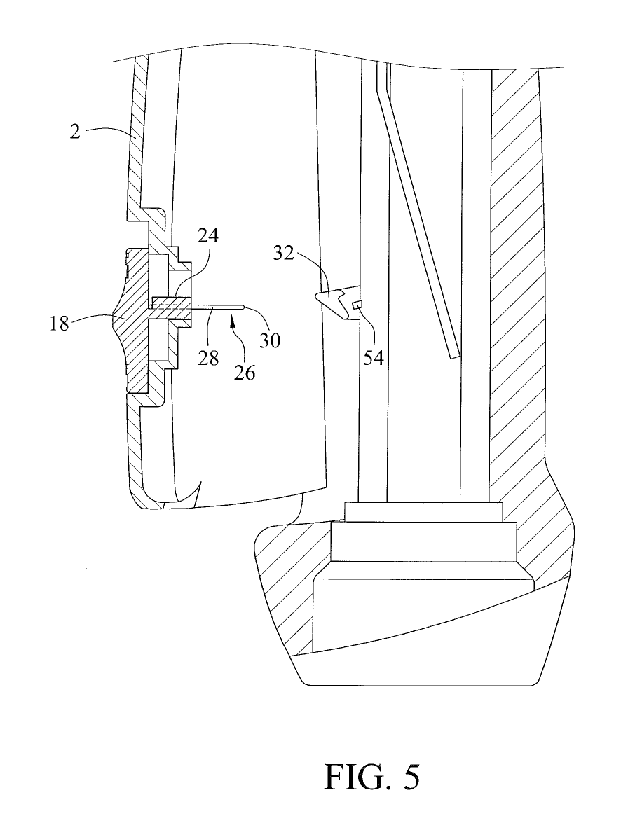

Referring to FIG. 5, the switch 18 is in a lower position, and the lever 10 is in the idle position.

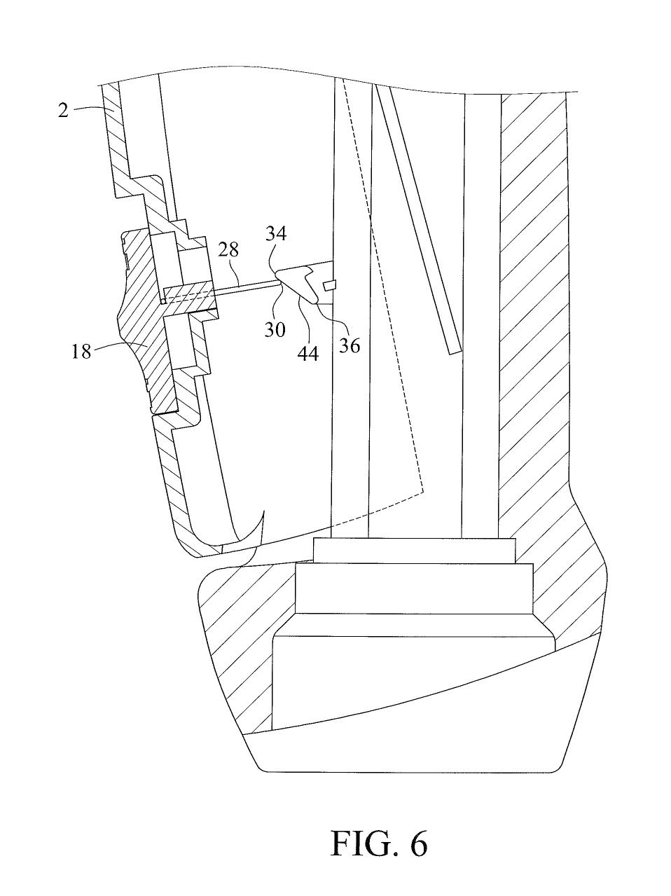

Referring to FIG. 6, the lever 10 is pivoted. The transverse ends 30 of the prongs 28 are moved toward the corner 36 from the corner 34 on the facet 44. Accordingly, the prongs 28 are pivoted downward. The prongs 28 tend to pivot upward and return to their original position relative to the switch 18.

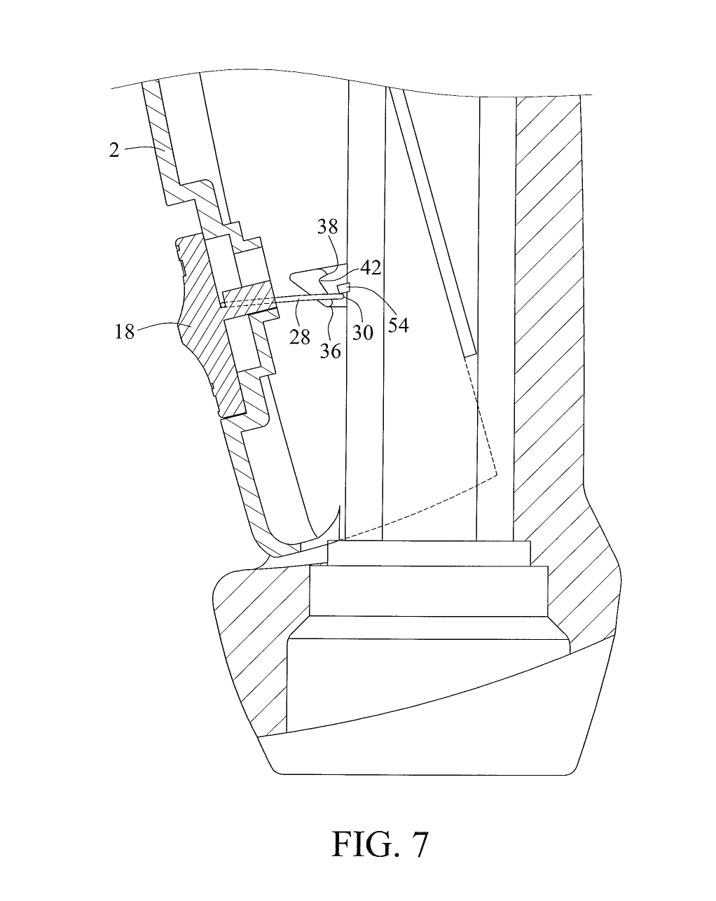

Referring to FIG. 7, the lever 10 is further pivoted. The transverse ends 30 of the prongs 28 are moved past the corner 36. The transverse ends 30 of the prongs 28 hit and are stopped by the stops 54 as the prongs 28 tend to pivot upward and return to the original position. The stops 54 prevent the transverse ends 30 of the prongs 28 from moving past the corner 38.

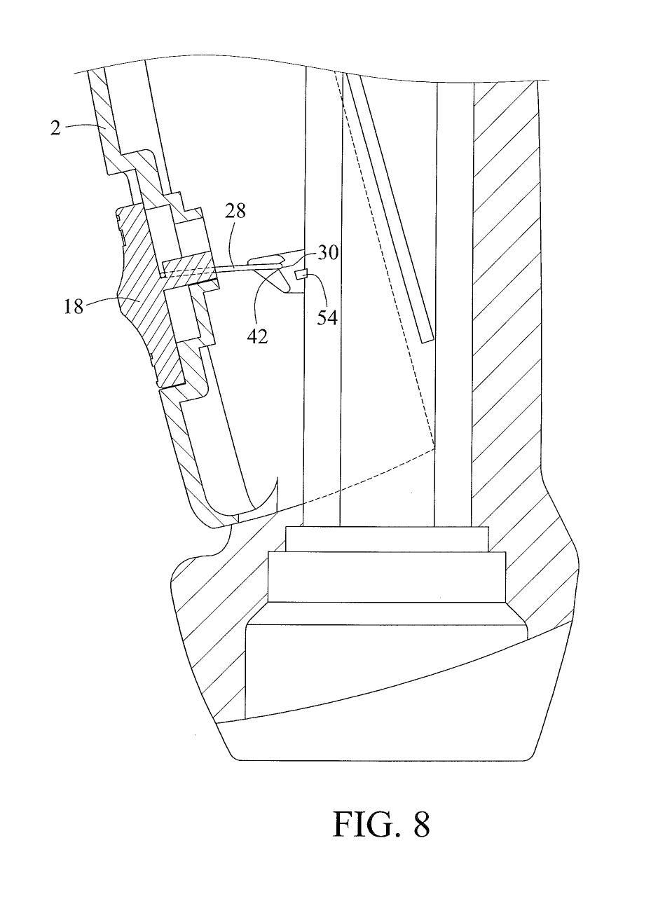

Referring to FIG. 8, the lever 10 is released. The transverse ends 30 of the prongs 28 snap into the recess 42 from the stops 54 as the prongs 28 tend to pivot upward and return to the original position. The transverse ends of the prongs 28 firmly rest in the recess 42. Hence, the lever 10 is locked in the active position. Thus, the user does not have to press the lever 10 against the spring 8 to keep on spraying water from the nozzle 4.

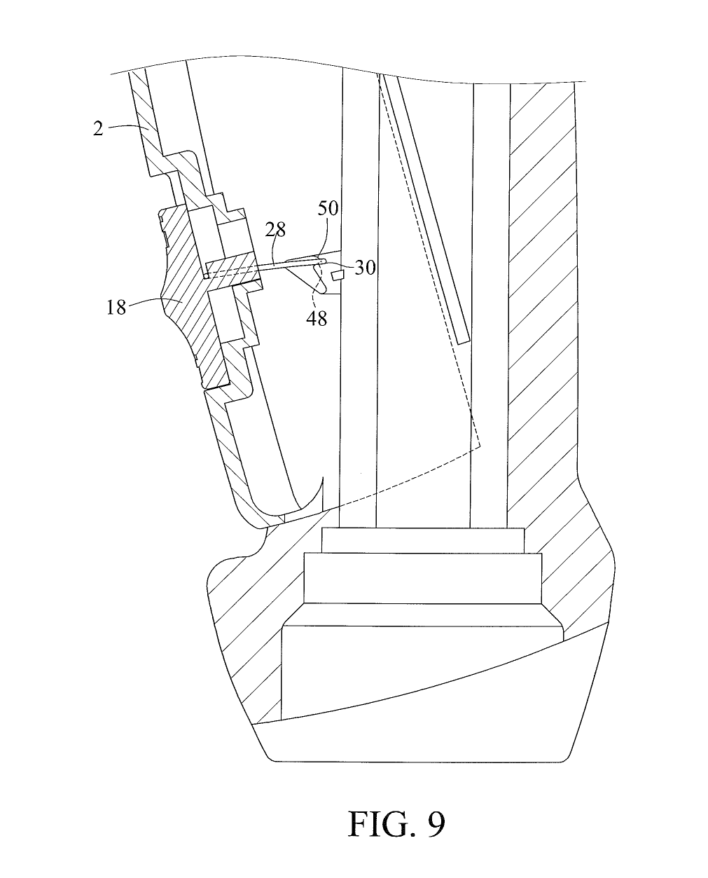

Referring to FIG. 9, the lever 10 is pivoted again to release the lever 10 from the active position. As the prongs 28 tend to pivot upward and return to the original position, the transverse ends 30 of the prongs 28 are sequentially moved on the facet 48, past the corner 38 and on the facet 50. The prongs 28 are pivoted upward as the transverse ends 30 thereof are moved on the facet 50.

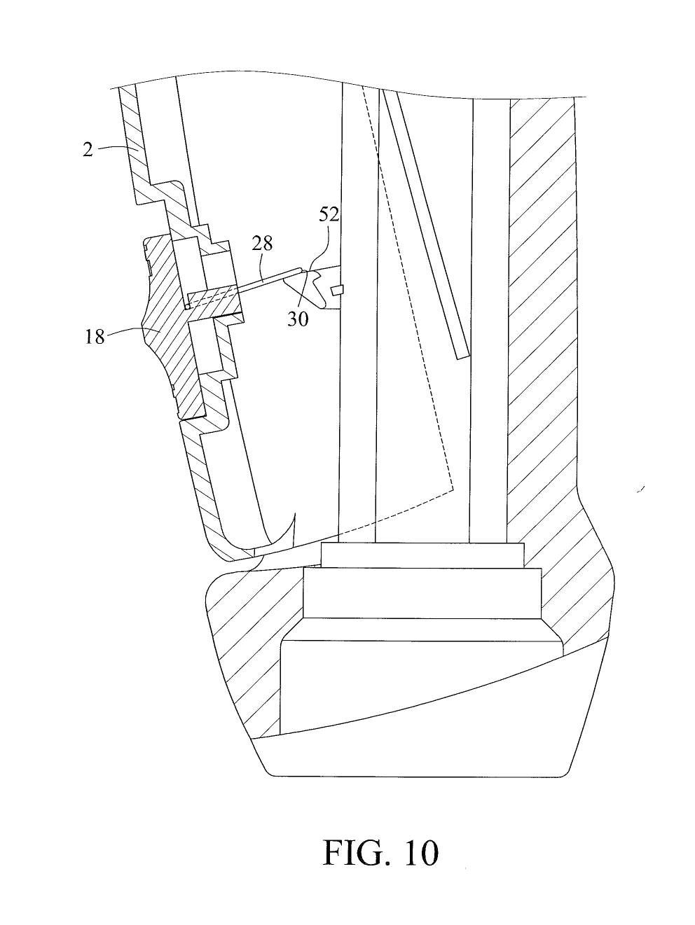

Referring to FIG. 10, the lever 10 is released. As the prongs 28 tend to pivot downward and return to the original position, the transverse ends 30 of the prongs 28 are sequentially moved past the corner 40 and on the facet 52. Then, the lever 10 is returned to the idle position.

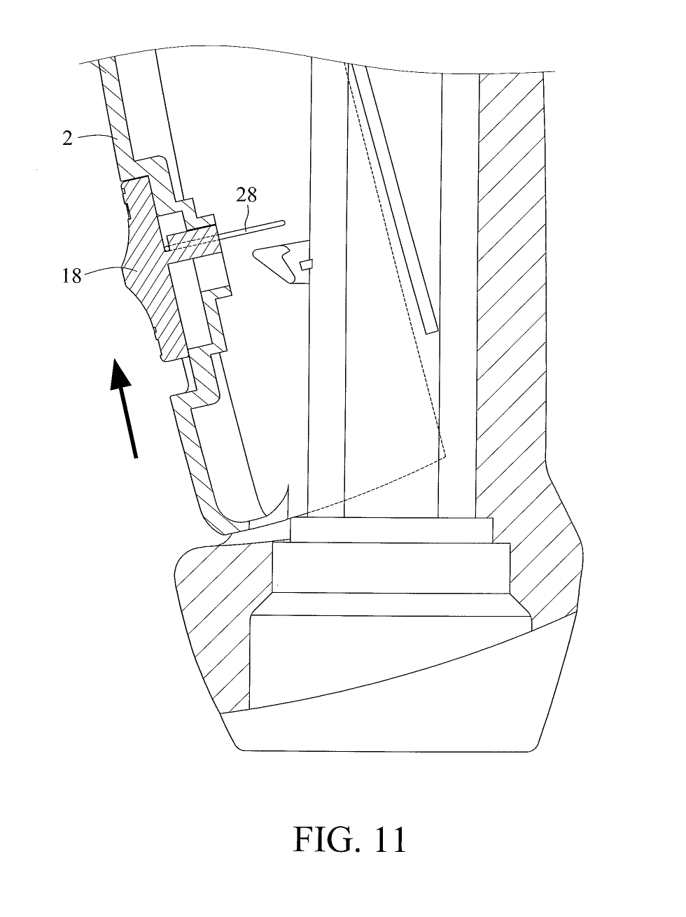

Referring to FIG. 11, the switch 18 is moved to an upper position. Thus, the catch 26 is engaged with the anchor 32 when the lever 10 is pivoted.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A sprinkler including:
a handle;
a nozzle connected to the handle;
a lever connected to the handle and pivotable between an idle position and an active position; and
a lever-locking apparatus including:
an anchor formed on the handle;
a stop formed on the handle;
a catch attached to the lever, wherein the catch is moved on the anchor, stopped by the stop and trapped on the anchor as the lever is pivoted toward the handle and released, wherein the catch is released from the anchor as the lever is again pivoted toward the handle and released.

2. The sprinkler according to claim 1, wherein the lever-locking apparatus includes a switch movably connected to the lever, wherein the catch is connected to the switch.

3. The sprinkler according to claim 2, wherein the lever includes an opening and two tracks on two opposite sides of the opening, wherein the switch includes two hooks engaged with the tracks.

4. The sprinkler according to claim 1, wherein the anchor includes a first corner, a second corner, a third corner, a fourth corner, a recess, a first facet between the first and second corners, a second facet between the second corner and the recess, a third facet between the recess and the third corner, a fourth facet between the third and fourth corners, and a fifth facet between the fourth and first corners, wherein the catch includes an elastic prong formed with a transverse end, wherein the transverse end of the prong is moved past the first facet and the second corner and stopped by the stop when the lever is pivoted, wherein the transverse end of the prong slides past the second facet into the recess when the lever is released, wherein the transverse end of the prong is moved past the third facet, the third corner and the fourth facet when the lever is pivoted again, wherein the transverse end of the prong is moved past the fourth corner and the fifth facet when the lever is released again.

5. The sprinkler according to claim 4, wherein the first, second, third and fourth corners are chamfered.

6. The sprinkler according to claim 4, wherein the lever-locking apparatus includes a switch movably connected to the lever, wherein the catch is connected to the switch.

7. The sprinkler according to claim 6, wherein the lever includes an opening and two tracks on two opposite sides of the opening, wherein the switch includes two hooks engaged with the tracks.

8. The sprinkler according to claim 1, wherein the anchor includes a first corner, a second corner, a third corner, a first facet between the first and second corners, a second facet between the second corner and the recess, a third facet between the recess and the third corner, and a fourth facet between the third and first corners, wherein the catch includes an elastic prong formed with a transverse end, wherein the transverse end of the prong is moved past the first facet and the second corner and stopped by the stop when the lever is pivoted, wherein the transverse end of the prong slides past the second facet into the recess when the lever is released, wherein the transverse end of the prong is moved past the third facet and the third corner when the lever is pivoted again, wherein the transverse end of the prong is moved past the fourth facet when the lever is released again.

9. The sprinkler according to claim 8, wherein the first, second and third corners are chamfered.

10. The sprinkler according to claim 8, wherein the lever-locking apparatus includes a switch movably connected to the lever, wherein the catch is connected to the switch.

11. The sprinkler according to claim 10, wherein the lever includes an opening and two tracks on two opposite sides of the opening, wherein the switch includes two hooks engaged with the tracks.
